(19) United States
(12) Patent Application Publication
(10) Pub. No.: US 2024/0117929 A1
(43) Pub. Date: Apr. 11, 2024

(54) DUAL GAS TRAILER WITH BLADDER SYSTEM

(71) Applicant: Caterpillar Inc., Peoria, IL (US)

(72) Inventors: Zachary J. Wilks, Spring, TX (US); Mitchel R. Deckard, Montgomery, TX (US)

(73) Assignee: Caterpillar Inc., Peoria, IL (US)

(21) Appl. No.: 17/938,554

(22) Filed: Oct. 6, 2022

(51) Int. Cl. F17C 1/00; F17C 5/00; F17C 7/00

(52) U.S. Cl. CPC F17C 1/00; F17C 5/00; F17C 7/00; F17C 2201/0109; F17C 2201/018; F17C 2205/013; F17C 2205/0326; F17C 2205/0332; F17C 2221/013; F17C 2221/033; F17C 2250/03; F17C 2250/043; F17C 2250/0439; F17C 2270/0171

(57) ABSTRACT

In some implementations, a dual gas transport system includes a trailer, one or more tanks mounted on the trailer, wherein each of the one or more tanks includes a first compartment and a second compartment, the first and second compartments being separated from each other by a bladder, and an electronic control module configured to control operations of the one or more tanks.

### TECHNICAL FIELD

The present disclosure relates generally to a dual gas trailer and, for example, to tanks with a bladder system.

### BACKGROUND

Internal combustion engines (e.g., natural gas engines) consume fuel (e.g., natural gas) and emit carbon dioxide (CO₂). For engines equipped with CO₂ capture systems, there is a need for CO₂ transport to a remote sequestration site. Currently, transportation of natural gas and CO₂ requires separate infrastructure (e.g., tank trailers). Use of separate infrastructure, including devoting at least one leg of each round-trip journey to the return of empty tanks, is inefficient, time-consuming, and costly.

The apparatus of the present disclosure solves one or more of the problems set forth above and/or other problems in the art.

### SUMMARY

In some implementations, a dual gas transport system includes a trailer; one or more tanks mounted on the trailer, wherein each of the one or more tanks includes a first compartment and a second compartment, the first and second compartments being separated from each other by a bladder; and an electronic control module configured to control operations of the one or more tanks.

In some implementations, a method of dual gas transport with a trailer having one or more tanks includes, sequentially, receiving natural gas, at a first site, into a first compartment of each of the one or more tanks; transporting the trailer from the first site to a second site; delivering the natural gas, at the second site, out of the first compartment of each of the one or more tanks; receiving CO₂, at the second site, into a second compartment of each of the one or more tanks, the second compartment being separated from the first compartment by a bladder; transporting the trailer from the second site to a third site; and delivering the CO₂, at the third site, out of the second compartment of each of the one or more tanks.

In some implementations, an electronic control module, configured to control operations of one or more tanks of a dual gas transport system, includes one or more memories; and one or more processors, configured to control actuation of a first valve, in fluid communication with a first compartment of each of the one or more tanks, to receive natural gas, at a first site, into the first compartment; control actuation of the first valve to deliver the natural gas, at a second site, out of the first compartment of each of the one or more tanks; control actuation of a second valve, in fluid communication with a second compartment of each of the one or more tanks, to receive CO₂, at the second site, into the second compartment, the second compartment being separated from the first compartment by a bladder; and control actuation of the second valve to deliver the CO₂, at a third site, out of the second compartment of each of the one or more tanks.

### BRIEF DESCRIPTION OF THE DRAWINGS

FIG. 1 is a diagram of an example implementation described herein.

FIG. 2 is a diagram of an example dual gas trailer described herein.

FIG. 3 is a diagram of an example tank described herein, showing a bladder in a first state.

FIG. 4 is a diagram of an example manifold described herein.

FIG. 5 is a diagram of an example tank described herein, showing the bladder in a second state.

FIG. 6 is a flowchart of an example implementation described herein.

### DETAILED DESCRIPTION

This disclosure relates to a dual gas trailer, which is applicable to any process that consumes compressed gas (e.g., natural gas) and captures CO₂. The process may be performed at any location that is remote from the compressed gas source and/or the sequestration site. The term “remote” may refer to any off-site field location independent of travel distance. The term “process” may refer to an operation associated with an industry such as, for example, mining, construction, farming, transportation, or another industry. For example, the process may be associated with oil & gas (e.g., drilling and/or hydraulic fracturing), electric power generation, gas compression, turbines, steam methane reformers, heaters, mining, dryers (e.g., sand drying), agriculture, forestry, asphalt/concrete plants, marine, and/or other industries. The dual gas trailer solution, described herein, enables use of the same infrastructure for inbound and outbound trips, which drives efficiency, time savings, and cost savings.

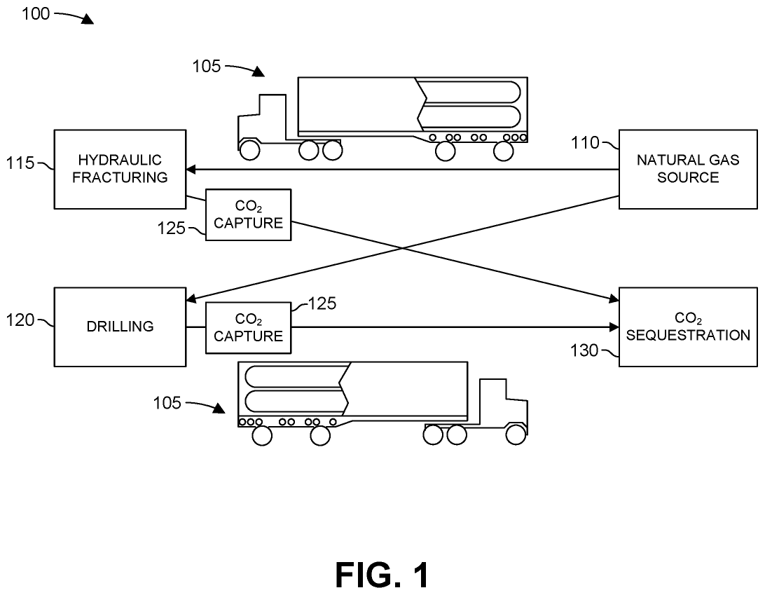

FIG. 1 is a diagram of an example implementation 100 described herein. For example, FIG. 1 depicts a partial cutaway side view of a dual gas trailer 105. In some examples, the implementation 100 may include less equipment, additional equipment, or alternative equipment compared to the example depicted in FIG. 1. The dual gas trailer 105 may be pulled by a semi-truck. Alternatively, the dual gas trailer 105 may be moved by another mode of transport, such as a different duty truck, among other examples.

As shown in FIG. 1, the dual gas trailer 105 receives compressed gas (e.g., natural gas) at a first site (e.g., a natural gas source 110). The dual gas trailer 105 is transported to a second site (e.g., a hydraulic fracturing site 115, such as a dynamic gas blending (DGB) fracturing site, or a drilling site 120, such as a hybrid gas drilling site, among other examples), where the compressed gas is offloaded. The dual gas trailer 105 receives CO₂ (e.g., from a CO₂ capture system 125) at the second site. The dual gas trailer 105 is transported to a third site (e.g., a CO₂ sequestration site 130, such as a CO₂ injection well, among other examples), where the CO₂ is offloaded.

As indicated above, FIG. 1 is provided as an example. Other examples may differ from what was described in connection with FIG. 1.

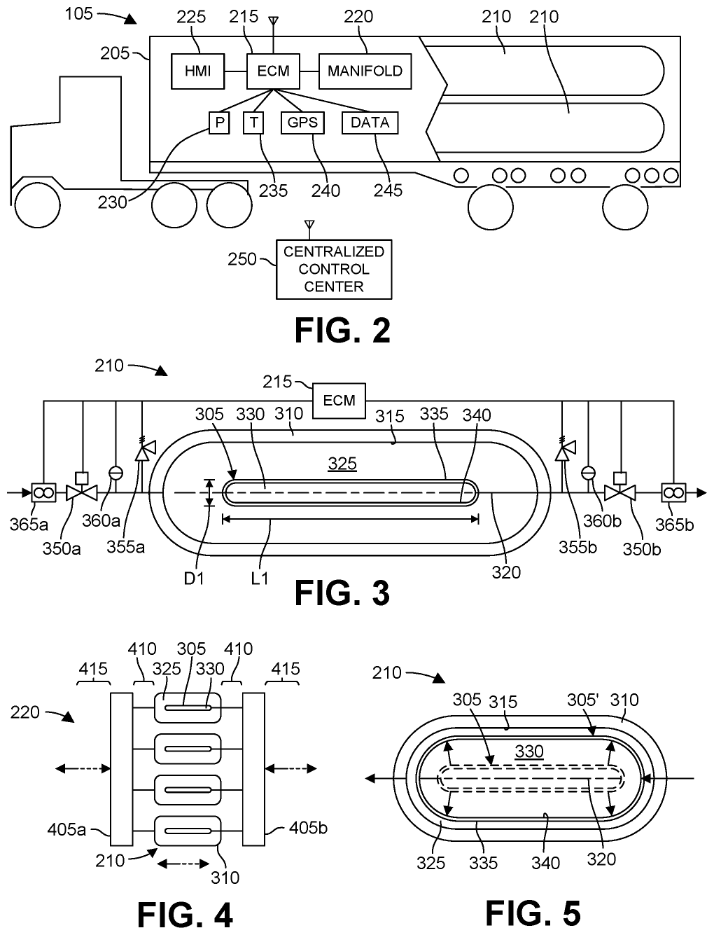

FIG. 2 is a diagram of an example dual gas trailer 105 described herein. In some examples, the dual gas trailer 105 may include less equipment, additional equipment, or alternative equipment compared to the example depicted in FIG. 2.

As shown in FIG. 2, the dual gas trailer 105 includes a frame 205, one or more tanks 210 mounted on the frame 205, an electronic control module 215 (ECM) configured to monitor and/or control operations of the dual gas-trailer 105 (e.g., including the one or more tanks 210) in association (e.g., communication) with a manifold 220, a human machine interface (HMI) 225, one or more pressure sensors 230, one or more temperature sensors 235, a global positioning system (GPS) 240, and a data connection 245.

The frame 205 may be a welded steel frame including a flatbed and a plurality of cross-beam supports.

The one or more tanks 210 may include a plurality of separate tanks (e.g., four tanks). The tanks 210 may be pneumatic tanks configured to hold compressed gas. The tanks 210 may be arranged, from an end-view, in a rectangular (e.g., square) configuration, among other examples.

The ECM 215 may control and/or monitor operations of the dual gas trailer 105. For example, the ECM 215 may control and/or monitor the operations of the dual gas trailer 105 based on information from the manifold 220, HMI 225, pressure sensors 230, temperature sensors 235, GPS 240, data connection 245, or operator controls, among other examples. The ECM 215 may be on-board the dual gas trailer 105. The ECM 215 may be, or include, a controller, among other examples. The ECM 215 may include one or more memories and one or more processors configured to implement instructions to control operations of the dual gas trailer 105. In some examples, the dual gas trailer 105 may be controlled manually (e.g., by performing a manual override of the ECM 215).

The manifold 220 may be mounted on the frame 205. The manifold 220 may include a plurality of separate manifolds (e.g., two manifolds). The manifold 220 may be in fluid communication with internal volumes of each of the tanks 210. The manifold 220 may be configured to distribute gas, from multiple tanks 210 (e.g., simultaneously, individually, or in batches of two or more tanks at the same time). Likewise, the manifold 220 may be configured to gather gas, into multiple tanks 210 (e.g., simultaneously, individually, or in batches of two or more tanks at the same time).

The HMI 225 may be on-board the dual gas trailer 105 for local control and monitoring. Alternatively, the HMI 225, or one or more additional HMI's, may be located remote from the dual gas trailer 105 for remote control and monitoring. In some examples, the HMI 225 may enable remote shutdown of operations of the dual gas trailer 105. The HMI 225 may be, or include, a touchscreen interface, among other examples.

The one or more pressure sensors 230 may be mounted on the tanks 210, and/or on the manifold 220, among other examples. The pressure sensors 230 may be analog or digital pressure transducers configured to measure compressed gas pressures. The pressure sensors 230 may be transmitters.

The one or more temperature sensors 235 may be mounted on the tanks 210, and/or on the manifold 220, among other examples. The temperature sensors 235 may be, or include, a contact or non-contact sensor, resistance temperature detector (RTD), thermocouple sensor, or thermistor, among other examples. The temperature sensors 235 may be configured to measure compressed gas temperatures. The temperature sensors 235 may be transmitters.

The GPS 240 may be on-board the dual gas trailer 105 to provide tracking of the dual gas trailer 105 during transport, as well as during loading and offloading, among other examples. The GPS 240 may be, or include, an assisted GPS, differential GPS, or non-differential GPS, among other examples.

The data connection 245 may include cellular or satellite telemetry communication with a centralized control center 250 located off-board the dual gas trailer 105. The centralized control center 250 may be configured to provide control and data acquisition across a fleet of dual gas trailers 105, simultaneously.

As indicated above, FIG. 2 is provided as an example. Other examples may differ from what was described in connection with FIG. 2.

FIG. 3 is a diagram of an example tank 210 described herein, showing a bladder 305 in a first state. For example, FIG. 3 depicts a sectional view of the tank 210. In some examples, the tank 210 may include less equipment, additional equipment, or alternative equipment compared to the example depicted in FIG. 3.

The tank 210 includes a tank body 310 having an inner cylindrical surface 315, defined about a longitudinal axis 320, being closed at both ends. The tank body 310 includes a first compartment 325, outside the bladder 305, and a second compartment 330, inside the bladder 305. The first compartment 325 and the second compartment 330 are separated from each other by the bladder 305 (which may also be referred to as an “inner bladder”). The bladder 305 may be free-floating within the tank body 310 or movably coupled (e.g., directly or indirectly) to the tank body 310 by one or more support structures, among other examples.

The bladder 305 includes a generally cylindrical body having a wall defining an outer surface 335 facing the first compartment 325 (e.g., facing the inner cylindrical surface 315 of the tank body 310) and an inner surface 340 facing the second compartment 330. The bladder 305 may have a similar shape to that of the tank body 310. The shape of the outer surface 335 of the bladder 305 may be configured to correspond to and/or conform to the inner cylindrical surface 315 of the tank body 310 (e.g., when the bladder 305 is inflated and/or deflated). A length L1 of the bladder 305 is defined parallel to the longitudinal axis 320, and a diameter D1 of the outer surface 335 is defined perpendicular to the longitudinal axis 320. In some examples, the length L1 of the bladder 305, when inflated, may be at least an order of magnitude greater than the length L1 of the bladder 305, when deflated. Likewise, the diameter D1 of the outer surface 335, when the bladder 305 is inflated, may be at least an order of magnitude greater than the diameter D1 of the outer surface 335, when the bladder 305 is deflated.

As shown in FIG. 3, the tank 210 may include separate plumbing for the first compartment 325 and the second compartment 330 to prevent cross-contamination between different gases. For example, the first compartment 325, and associated flow lines, may only contain natural gas, whereas the second compartment 330, and associated flow lines, may only contain CO₂. In some examples, surfaces contacting the first compartment 325 (e.g., the inner cylindrical surface 315 of the tank body 310, the outer surface 335 of the bladder 305, and flow lines (on the left side of FIG. 3) in fluid communication with the first compartment 325) may only be in contact with a first gas (e.g., natural gas), whereas surfaces contacting the second compartment 330 (e.g., the inner surface 340 of the bladder 305 and flow lines (on the right side of FIG. 3) in fluid communication with the second compartment 330) may only be in contact with the second gas (e.g., CO₂). Advantageously, as a result of the isolation of the different gases, the respective surfaces may consist of different, select materials that are compatible with (e.g., being resistant to corrosion, stress cracking, or embrittlement, among other examples) only the first gas or the second gas, but not both, which may reduce a cost of construction of the tank 210 and/or improve efficiency, durability, and/or usability of the tank 210. In some examples, the respective surfaces may consist of the same material(s) even while being exposed to unique gases.

In some examples, containment of natural gas in the first compartment 325, outside the bladder, as opposed to the second compartment 330, inside the bladder, may be advantageous due to the first compartment 325 having a greater volume and/or pressure capacity compared to the second compartment 330, in combination with natural gas being a higher value gas compared to CO₂. In other words, there is a cost advantage to transport natural gas outside the bladder and CO₂ inside the bladder, as opposed to the reverse configuration. This advantage may be particularly valuable when the dual gas trailer 105 is used in the example implementation shown in FIG. 1.

The dual gas trailer 105 includes, in association with the one or more tanks 210 and/or in communication with the ECM 215, one or more flow control valves 350 (350a-b), one or more pressure relief valves 355 (355a-b), one or more indicators 360 (360a-b), and one or more flow meters 365.

The one or more flow control valves 350 may include a first flow control valve 350a, in fluid communication with the first compartment 325, and a second flow control valve 350b, in fluid communication with the second compartment 330. The flow control valves 350 may be gate valves, among other examples. In some examples, the flow control valves 350 may be integrated with the manifold 220. In some examples, one or more additional valves, like the flow control valves 350, may be connected in fluid communication with a field-side of the manifold 220, opposite the one or more tanks 210.

Actuation of each of the one or more flow control valves 350 may controlled independently of each other. For example, the flow control valves 350 may be opened and closed to control filling and emptying each compartment 325/330 independently. In some examples, actuation of the flow control valves 350 may be controlled to manage outlet pressures from each tank 210 and/or each compartment 325/330 individually. Actuation of the flow control valves 350 may be controlled by the ECM 215 (e.g., one or more processors thereof). For example, the ECM 215 may control actuation of the first flow control valve 350a to regulate gas flow into and out of the first compartment 325. Likewise, the ECM 215 may control actuation of the second flow control valve 350b to regulate gas flow into and out of the second compartment 330. In some examples, the ECM 215 may control actuation of the flow control valves 350 based on state information from the manifold 220, operator information from the HMI 225, pressure information from the one or more pressure sensors 230, temperature information from the one or more temperature sensors 235, location information from the GPS 240, and/or operation information from the data connection 245.

The one or more pressure relief valves 355 may include a first pressure relief valve 355a, in fluid communication with the first compartment 325, and a second pressure relief valve 355b, in fluid communication with the second compartment 330. The pressure relief valves 355 may be spring-loaded or pilot operated, among other examples. The pressure relief valves 355 may prevent over-pressurization of the first compartment 325 and/or the second compartment 330.

The one or more indicators 360 (360a-b) may include a first indicator 360a, in fluid communication with the first compartment 325, and a second indicator 360b, in fluid communication with the second compartment 330. The indicators 360 may be, or include, pressure or temperature transducers, or internal or external gas composition sensors (e.g., capacitive electrode sensors), among other examples. In some examples, the indicators 360 may be configured to monitor gas quality within the tanks 210 and/or within one or more gas flow streams into or out of the first compartment 325 and/or the second compartment 330. In some examples, the indicators 360 may be configured to detect gas leaks outside the tanks 210.

The one or more flow meters 365 may include a first flow meter 365a, in fluid communication with the first compartment 325, and a second flow meter 365b, in fluid communication with the second compartment 330. The flow meters 365 may be mass, velocity, differential pressure, or positive displacement, among other examples. The flow meters 365 may be configured to determine gas volumes within the tanks 210 and/or within one or more gas flow streams into or out of the first compartment 325 and/or the second compartment 330.

As indicated above, FIG. 3 is provided as an example. Other examples may differ from what was described in connection with FIG. 3.

FIG. 4 is a diagram of an example manifold 220 described herein. In some examples, the manifold 220 may include less equipment, additional equipment, or alternative equipment compared to the example depicted in FIG. 4.

The manifold 220 includes a body 405 (405a-b) mounted on the dual gas trailer 105. The body 405 includes a first body 405a and a second body 405b. The body 405 may include a different number of parts from what was described in connection with FIG. 4 (e.g., only one part or more than two parts, among other examples). Each body 405 includes a plurality of tank-side ports 410 and at least one field-side port 415. A separate port of the plurality of tank-side ports 410 is in fluid communication with a corresponding tank of the plurality of tanks 210. At least one field-side port 415 is configured to be connected in fluid communication with a gas source (e.g., natural gas or CO₂, among other examples).

As shown in FIG. 4, the manifold 220 is configured to combine a first gas from the first compartment 325 of each of the plurality of tanks 210 within the first body 405a (e.g., simultaneously). The solid arrows indicate that the first gas from the first compartments 325 is routed through the corresponding tank-side ports 410 (on the left side of FIG. 4). The solid arrows also indicate that the manifold 220 is further configured to distribute the combined first gas, within the first body 405a, through the field-side port 415 (on the left side of FIG. 4). The solid arrows also indicate that, with the bladder 305 in a first state (shown in FIG. 3), the manifold 220 is further configured to gather a second gas, through the field-side port 415 (on the right side of FIG. 4), into the second body 405b. Likewise, the solid arrows also indicate that the second gas gathered into the second body 405b is routed through the tank-side ports 410 (on the right side of FIG. 4) into the corresponding second compartment 330 of each of the plurality of tanks 210 (e.g., simultaneously). In some examples, the bladder 305 may expand in size from the first state (shown in FIG. 3) to a second state (shown in FIG. 5), based on filling the second gas into the bladder 305. In some examples, the dual gas trailer 105 may be used to transport only one gas (e.g., one-way trip, inbound trip only, or outbound trip only, among other examples). Therefore, the bladder 305 may not be expanded, and/or may not be configured to expand, in every implementation.

As indicated by the dashed arrows in FIG. 4, the manifold 220 is further configured to operate in reverse. For example, the manifold 220 is configured to combine the second gas from the second compartment 330 of each of the plurality of tanks 210 within the second body 405b (e.g., simultaneously). The dashed arrows indicate that as the second gas from the second compartments 330 is routed through the corresponding tank-side ports 410 (on the right side of FIG. 4), the bladder 305 may contract in size from the second state, returning to the first state. The dashed arrows also indicate that the manifold 220 is further configured to distribute the combined second gas, within the second body 405b, through the field-side port 415 (on the right side of FIG. 4). The dashed arrows also indicate that, with the bladder 305 in the first state, the manifold 220 is further configured to gather a third gas (which may be the same as the first gas) (e.g., when the example implementation shown in FIG. 1 is completed, the third gas may represent refilling of the dual gas trailer 105 with natural gas at the natural gas source 110), through the field-side port 415 (on the left side of FIG. 4), into the first body 405a. Likewise, the dashed arrows also indicate that the third gas gathered in the first body 405a is routed through the tank-side ports 410 (on the left side of FIG. 4) into the corresponding first compartment 325 of each of the plurality of tanks 210 (e.g., simultaneously).

As indicated above, FIG. 4 is provided as an example. Other examples may differ from what was described in connection with FIG. 4.

FIG. 5 is a diagram of an example tank 210 described herein, showing the bladder 305 in the second state (denoted as 305′). For example, FIG. 5 depicts a sectional view of the tank 210. As shown in FIG. 5, the bladder 305/305′ has expanded in size, from the first state (denoted as 305, shown in dashed lines), radially and longitudinally outward towards the inner cylindrical surface 315 of the tank body 310, to the second state. In FIG. 5, for sake of clarity, clearance is shown around the outside of the bladder 305′, between the outer surface 335 and the tank body 310 (e.g., the inner cylindrical surface 315). In some examples, the outer surface 335 of the bladder 305′ may be configured not to contact the tank body 310 (e.g., indirect contact). In other examples, the outer surface 335 may be configured to contact the tank body 310 (e.g., continuously, discontinuously, or only on an underside of the bladder 305′, among other examples). Contact, or lack thereof, between the bladder 305′ and the tank body 310 may be based on certain design and/or operational aspects (e.g., relative shapes of the bladder 305′ and the tank body 310, bladder support structures, gas pressures, or differential pressures, among other examples).

As indicated by the arrows, expansion of the bladder 305/305′ to the second state may be associated with emptying gas out of the first compartment 325 and/or filling another gas into the second compartment 330. In some examples, filling and/or emptying operations may occur during expansion of the bladder 305/305′. In some examples, emptying operations may occur during expansion of the bladder 305/305′, whereas filling operations may occur after expansion of the bladder 305/305′. In some examples, emptying operations may occur without expansion of the bladder 305/305′, whereas filling operations may occur during expansion of the bladder 305/305′. In some examples, filling and/or emptying operations may occur before or after expansion of the bladder 305/305′. In some examples, filling and/or emptying of the bladder 305/305′ may be based on a differential pressure between the first compartment 325 and the second compartment 330. In some examples, filling and/or emptying of the bladder 305/305′ may cause expansion of the bladder 305/305′. Reversing the process illustrated in FIG. 5, to cause contraction of the bladder 305/305′ from the second state to the first state (e.g., in association with emptying gas out of the second compartment 330 and/or filling another gas into the first compartment 325), may involve any of the operational aspects described herein, without limitation.

As a result of the bladder 305 expanding to the second state, a volume of the first compartment 325 (in FIG. 5) is less than a volume of the first compartment 325 (in FIG. 3). Likewise, a volume of the second compartment 330 (in FIG. 5) is greater than a volume of the second compartment 330 (in FIG. 3). In some examples, a ratio of the greater volume to the lesser volume may be 10:1 or more (e.g., 100:1 or more).

As indicated above, FIG. 5 is provided as an example. Other examples may differ from what was described in connection with FIG. 5.

### INDUSTRIAL APPLICABILITY

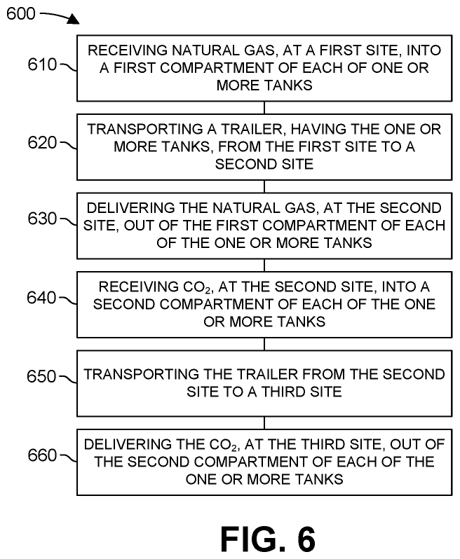

FIG. 6 is a flowchart of an example implementation 600, described herein, that solves one or more of the problems set forth above and/or other problems in the art. At 610, natural gas is received, at a first site 110, into the first compartment 325 of each of the one or more tanks 210. At 620, the dual gas trailer 105, having the one or more tanks 210, is transported from the first site 110 to a second site 115/120. At 630, the natural gas is delivered, at the second site 115/120, out of the first compartment 325 of each of the one or more tanks 210. At 640, CO₂ is received, at the second site 115/120, into the second compartment 330 of each of the one or more tanks 210. At 650, the dual gas trailer 105 is transported from the second site 115/120 to a third site 130. At 660, the CO₂ is delivered, at the third site 130, out of the second compartment 330 of each of the one or more tanks 210.

As indicated above, FIG. 6 is provided as an example. Other examples may differ from what was described in connection with FIG. 6. For instance, the receiving of the CO₂, at 640, may occur at a fourth site that is remote from the second site. In some examples, the first and third sites may be in the same location.

Certain processes and/or equipment associated with oil & gas (e.g., drilling and/or hydraulic fracturing), electric power generation, gas compression, turbines, steam methane reformers, heaters, mining, dryers (e.g., sand drying), agriculture, forestry, asphalt/concrete plants, marine, and/or other industries (e.g., internal combustion engines, such as natural gas engines) may consume fuel (e.g., natural gas) and emit carbon dioxide (CO₂). For processes and/or equipment equipped with CO₂ capture systems, there is a need for CO₂ transport to a remote sequestration site. Currently, transportation of natural gas and CO₂ requires separate infrastructure (e.g., tank trailers). Use of separate infrastructure, including devoting at least one leg of each round-trip journey to the return of empty tanks, is inefficient, time-consuming, and costly.

The dual gas trailer 105 solution, and application thereof, described herein, enables use of the same infrastructure for inbound and outbound trips associated with the transport of compressed gas and CO₂, which drives efficiency, time savings, and cost savings.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

1. A dual gas transport system, comprising:
a trailer;
one or more tanks mounted on the trailer;
wherein each of the one or more tanks includes a first compartment and a second compartment, the first and second compartments being separated from each other by a bladder;
a manifold mounted on the trailer, the manifold comprising a first flow line in fluid communication with the first compartment and a second flow line in fluid communication with the second compartment;
wherein the first compartment and the first flow line are fluidly isolated from the second compartment and the second flow line;
a first material configured to form a first coating resistant to degradation by a first gas, the first material comprising:
an outer surface of the bladder facing the first compartment, and
at least one of an inner surface of the one or more tanks facing the first compartment or an inner surface of the first flow line;
a second material comprising an inner surface of the bladder facing the second compartment and an inner surface of the second flow line, the second material configured to form a second coating resistant to degradation by a second gas;
wherein the first material is different from the second material; and
an electronic control module configured to control operations of the one or more tanks.

2. (canceled)

3. The dual gas transport system of claim 1, wherein:
the one or more tanks include a plurality of tanks;
the manifold is associated with the first compartment of each of the plurality of tanks;
wherein the manifold is configured to distribute gas, from the first compartment of each of the plurality of tanks, simultaneously; and
wherein the manifold is further configured to gather gas, into the first compartment of each of the plurality of tanks, simultaneously.

4. The dual gas transport system of claim 1, wherein the trailer is configured to sequentially transition between:
a first state wherein the first compartment of the one or more tanks expands to a maximum natural gas volume while the second compartment of the one or more tanks contracts to a minimum CO₂ volume; and
a second state wherein the first compartment of the one or more tanks contracts to a minimum natural gas volume while the second compartment of the one or more tanks expands to a maximum CO₂ volume.

5. The dual gas transport system of claim 4,
wherein the first compartment is configured to connect to an outlet of a natural gas source and to an inlet of at least one of a hydraulic fracturing site or a drilling site, and
wherein the second compartment is configured to connect to an inlet of a CO₂ injection well.

6. (canceled)

7. The dual gas transport system of claim 1, wherein the trailer further includes, in communication with the electronic control module:
a human machine interface;
one or more pressure sensors;
one or more temperature sensors;
a global positioning system; and
a data connection.

8. The dual gas transport system of claim 7, wherein the data connection includes at least one of cellular or satellite telemetry communication with a centralized control center.

9. The dual gas transport system of claim 1, wherein the trailer further includes, in communication with the electronic control module:
a first valve in fluid communication with the first compartment; and
a second valve in fluid communication with the second compartment.

10. The dual gas transport system of claim 1, wherein the trailer further includes, in communication with the electronic control module:
a first pressure relief valve in fluid communication with the first compartment; and
a second pressure relief valve in fluid communication with the second compartment.

11. The dual gas transport system of claim 1,
wherein each of the one or more tanks includes a tank body having an inner cylindrical surface defining a longitudinal axis, and
wherein the bladder includes a generally cylindrical body having a wall defining:
the outer surface facing the first compartment; and
the inner surface facing the second compartment.

12. The dual gas transport system of claim 11, wherein the outer surface of the wall of the bladder is facing the inner cylindrical surface of the tank body, and wherein a shape of the outer surface is configured to conform to the inner cylindrical surface.

13. The dual gas transport system of claim 1, wherein the manifold further comprises:
a body mounted on the trailer;
one or more tank-side ports in the body, wherein a separate port of the one or more tank-side ports is in fluid communication with a corresponding tank of the one or more tanks; and
at least one field-side port in the body, wherein the at least one field-side port is configured to be connected in fluid communication with a source of at least one of natural gas or CO₂.

14. (canceled)

15. (canceled)

16. (canceled)

17. (canceled)

18. (canceled)

19. (canceled)

20. (canceled)

21. A dual gas transport system, comprising:
a trailer;
one or more tanks mounted on the trailer;
wherein each of the one or more tanks includes a first compartment and a second compartment, the first and second compartments being separated from each other by a bladder;
a first material comprising an outer surface of the bladder facing the first compartment, the first material configured to form a first coating resistant to degradation by a first gas;
a second material comprising an inner surface of the bladder facing the second compartment, the second material configured to form a second coating resistant to degradation by a second gas;
wherein the first material is different from the second material;
an electronic control module configured to control operations of the one or more tanks; and
wherein the first compartment is defined outside the bladder, the first compartment being configured to contain natural gas, wherein the second compartment is defined inside the bladder, the second compartment being configured to contain CO₂, and wherein the bladder is free-floating within the first compartment of the tank such that no portion of the outer surface of the bladder facing the first compartment is affixed to the inner surface of the tank facing the first compartment.

22. The dual gas transport system of claim 1, wherein the one or more tanks include a plurality of tanks.

23. The dual gas transport system of claim 22, further comprising:
a manifold mounted on the trailer, the manifold being associated with the first compartment of each of the plurality of tanks;
wherein the manifold is configured to distribute gas, from the first compartment of each of the plurality of tanks, simultaneously; and
wherein the manifold is further configured to gather gas, into the first compartment of each of the plurality of tanks, simultaneously.

24. The dual gas transport system of claim 21, wherein the trailer is configured to sequentially transition between:
a first state wherein the first compartment of the one or more tanks expands to a maximum natural gas volume while the second compartment of the one or more tanks contracts to a minimum CO₂ volume; and
a second state wherein the first compartment of the one or more tanks contracts to a minimum natural gas volume while the second compartment of the one or more tanks expands to a maximum CO₂ volume.

25. The dual gas transport system of claim 24, wherein:
the first compartment is configured to connect to an outlet of a natural gas source and to an inlet of at least one of a hydraulic fracturing site or a drilling site; and
wherein the second compartment is configured to connect to an inlet of a CO₂ injection well.

26. The dual gas transport system of claim 21, wherein the trailer further includes, in communication with the electronic control module:
a first valve in fluid communication with the first compartment; and
a second valve in fluid communication with the second compartment.

27. The dual gas transport system of claim 21, wherein the trailer further includes, in communication with the electronic control module:
a first pressure relief valve in fluid communication with the first compartment; and
a second pressure relief valve in fluid communication with the second compartment.

28. The dual gas transport system of claim 21,
wherein each of the one or more tanks includes a tank body having an inner cylindrical surface defining a longitudinal axis; and
wherein the bladder includes a generally cylindrical body having a wall defining:
the outer surface facing the first compartment; and
the inner surface facing the second compartment.

29. The dual gas transport system of claim 22, further comprising a manifold including:
a body mounted on the trailer;
a plurality of tank-side ports in the body, wherein a separate port of the plurality of tank-side ports is in fluid communication with a corresponding tank of the plurality of tanks; and
at least one field-side port in the body, wherein the at least one field-side port is configured to be connected in fluid communication with a source of at least one of natural gas or CO₂.
